(19) United States
(12) Patent Application Publication
(10) Pub. No.: US 2018/0113964 A1
(43) Pub. Date: Apr. 26, 2018

(54) METHOD FOR COMPUTER-SUPPORTED DEVELOPMENT OF AN OVERALL SYSTEM CONSISTING OF SUBSYSTEMS

(71) Applicant: SIEMENS AKTIENGESELLSCHAFT, München (DE)

(72) Inventors: Bernhard Fischer, Töging A. Inn (DE); Gunter Freitag, München (DE); Andre Marek, Dietramszell (DE); Christian Stanek, Marquartstein (DE)

(21) Appl. No.: 15/569,890

(22) PCT Filed: Apr. 15, 2016
(86) PCT No.: PCT/EP2016/058309

§ 371 Date: Oct. 27, 2017

(30) Foreign Application Priority Data
Apr. 29, 2015 (DE) 10 2015 207 932.5

(51) Int. Cl. G06F 17/50; G06F 8/35

(52) U.S. Cl. CPC G06F 17/5009; G06F 2217/86; G06F 17/5095; G06F 8/35

(57) ABSTRACT

A method is provided for computer-supported development of an overall system including subsystems. The subsystems include real products and virtual behavior models simulated in real-time, used in phases of the right branch of the V-model, including development steps “MIL,” “SIL” and “VPIL.” Each development step includes an environment model, a reusable multiphysics model and software. The development step “HIL” also includes another physics unit simulating parts of the hardware of a product that are only virtually present. The method provides a temporally parallel and spatially divided integration, and a corresponding test, of components on various levels (e.g., the right-hand branch of a V-model performed by the system developer). Open-loop and closed-loop control functions or processes for the overall system level may already be developed, even though all of the subsystems are not yet present. No parallel systems are required where new processes are run in advance.

### CROSS-REFERENCE TO RELATED APPLICATIONS

This application is the National Stage of International Application No. PCT/EP2016/058309, filed Apr. 15, 2016, which claims the benefit of German Patent Application No. DE 102015207932.5, filed Apr. 29, 2015. The entire contents of these documents are hereby incorporated herein by reference.

### BACKGROUND

The development of complex functions at the level of overall systems requires knowledge of the performance of all subsystems. Complex functions are meant to be functions accessing information from various subsystems and outputting control commands to various subsystems. Normally, the validation of these functions is performed on the complete overall system. However, the validation may require the availability of the overall system. For the validation of subsystems, the input vectors for the subsystems may be available. The validation also presupposes knowledge of the respective performance of the subsystems involved in the overall system.

In a model-driven development of hardware-related software, models are currently configured to control and to route, and a corresponding control code is loaded onto a target system. Such a development typically has development stages MIL (“model in the loop”), SIL (“software in the loop”), VPIL (“virtual platform in the loop”) (e.g., software running on a virtual hardware simulating the target system), and HIL (“hardware in the loop”) (e.g., software running on information communication technology hardware driving an existing prototype).

As a development model, the V model represents the current standard of development for IT systems and may be the basis for the interdisciplinary system development. On the left-hand branch of the V model, there is ever-increasing detailing of the analysis and of the design of systems up to components and the implementation of the software and production of prototypes at the end. On the right-hand branch of the V model, integration steps and tests take place, starting from the component level up to the system level and through the acceptance test of the overall system.

More frequently, the development of complex hardware/software is becoming an interdisciplinary task bringing mechatronics, electronics and software together to become a functional unit. The interdisciplinary task is lengthy, expensive and renders the individual disciplines interdependent. In most cases, components may only be tested completely when the entire system is available, with correspondingly high costs for the prototypes. Pure software models encounter limits in this process because the software models never reproduce reality at up to 100%.

### SUMMARY AND DESCRIPTION

The scope of the present invention is defined solely by the appended claims and is not affected to any degree by the statements within this summary.

One or more of the present embodiments may obviate one or more of the drawbacks or limitations in the related art. For example, a method is provided for computer-supported development of an overall system including subsystems such that the disadvantages mentioned above are avoided as far as possible and an overall system development may be performed in a more rapid, distributed, reliable and systematic manner.

One or more of the present embodiments provides a method for computer-supported development of an overall system including subsystems. The method includes a combination of real product models and virtual performance models simulated in real time and used in the phases of the right-hand branch of the V model. The development stages “MIL”, “SIL” and “VPIL” each have an environmental model, a reusable multiphysics model and a software, and the development stage “HIL”, apart from the environmental model, also has a residual physics unit for simulation of the parts of the hardware of a product that are only present virtually. As such, a temporarily parallel and spatially distributed integration and a corresponding test of components at different levels (e.g., the right-hand branch of a V model) is provided taking place on the part of the system developer. For example, control and regulating functions or processes for the overall system level may already be developed, even though not all the subsystems are present. Parallel installations may not be necessary on which new processes are run in in advance.

For example, safety-critical systems may be tested overall in the laboratory before the real overall system is tested in a real environment. Some components of the development method (e.g., real-time multiphysics models from the simulation and automatic system tests of the “HIL” development stage) may be reused.

### BRIEF DESCRIPTION OF THE DRAWINGS

FIG. 1 shows an overview representation of a method according to an embodiment.

FIG. 2 shows an overview representation of a method according an embodiment with an example E-car drive system on the HIL.

FIG. 3 is a further representation of the embodiment of FIG. 2.

### DETAILED DESCRIPTION

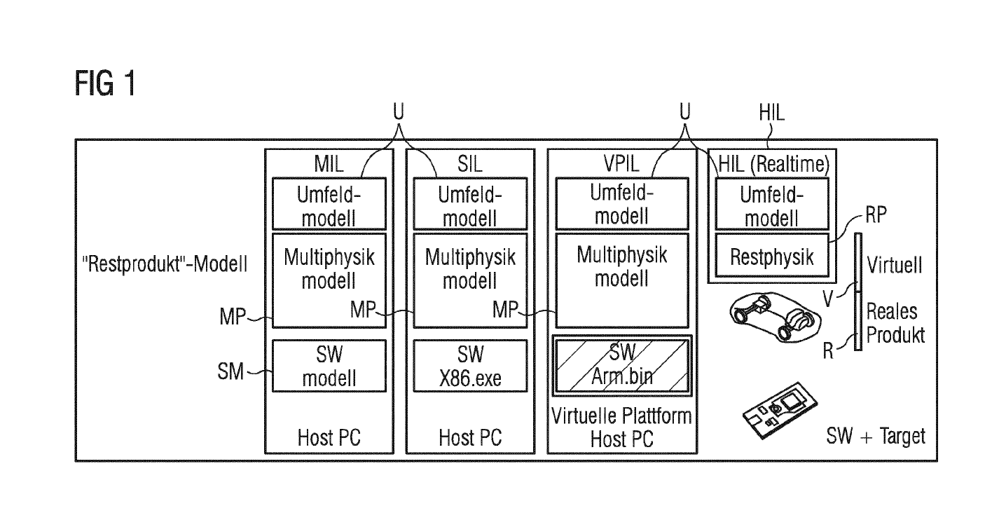

FIG. 1 shows an overview representation an embodiment of a method with development stages “MIL”, “SIL”, “VPIL”, the development stages having an environmental model U, a reusable multiphysics model MP, and a software model SM or a software and a development stage “HIL” which, apart from the environmental model U, also has a residual physics unit RP for real-time simulation of the parts V of the hardware of a product (e.g., the parts V only present virtually). The part V present virtually is supplemented with the components present in reality to form the respective overall system or overall product.

The test vectors simulate the subsystems. Test vectors are dynamically generated from the measurement of the available subsystems. The unavailable subsystems are generated dynamically by simulation. The measurement and simulation occur simultaneously in real time. The environment of the overall system is also simulated. The input and output variables of the overall system are generated dynamically and situatively. The information generated during this process is provided to all subsystems.

The model-driven development of hardware-related software is extended to a “residual product” and the system environment. The software, the “residual product,” and system environment is described as a performance model. In the “HIL” development stage (e.g., similar to “augmented reality”) a virtual world is mixed with the real world. The non-existing hardware or the hardware (e.g., the performance of the hardware may not be shown) is modeled as a real-time model and controls the interface to the existing hardware. As such, the “residual product” appears to be completely present for the software.

The present embodiments are explained in greater detail below using the example of an electric car having wheel hub drive. The present embodiments are not restricted to this example.

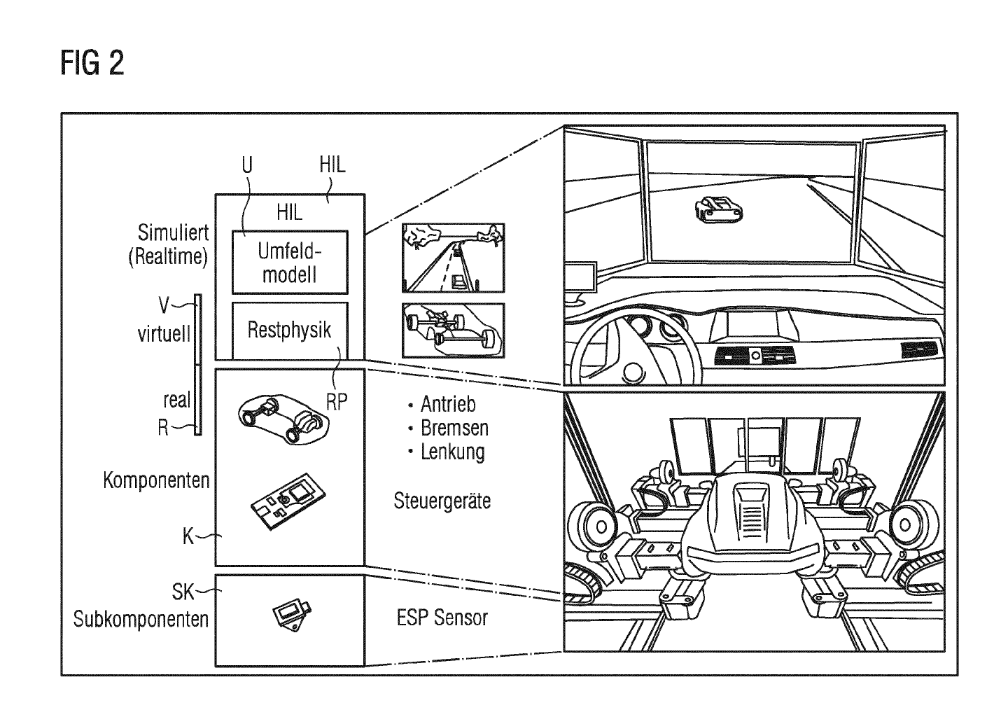

FIG. 2 shows an overview representation of an E-car drive system at the “HIL.” Subcomponents SK (e.g., an ESP sensor) and components (e.g., the drive, brakes, the steering and control devices) are present as real products R. In the development stage HIL, the part V is only present virtually, simulated in real time with the aid of the environmental model U and the residual physics unit RP, such that in the respective phases of the V model, for example, the reactions of the overall system Ecar are representable in virtual reality by a virtual vehicle cockpit.

For example, as existing hardware, only the drive train is constructed on the test bench. On the vehicle test bench, the wheel speeds and torques are measured. The transverse dynamics are calculated from the simulated system performance, and with this information, an accelerometer is simulated. From the measured longitudinal dynamics and a simulatively calculated transverse dynamics, the location and position of the vehicle, and the friction factor of the ground, is determined for the vehicle.

The performance of non-existing hardware, or respectively, the hardware, may not be shown (e.g., the structure, the chassis and/or the steering) and is modeled as real-time model, controlling the interface to the existing hardware (e.g., the drive train). In this way, it appears to the software as if the “residual product” were actually present.

A system test (e.g., the “Elchtest”) automatically generates the drive to the drive train component. For example, generation of a test case for the drive train component may be avoided. Furthermore, a separate data recording is saved, because data logging takes place via the overall system model.

Safety-critical systems (e.g., drive, brake and steering) may be tested with the overall vehicle software in the laboratory before a driver enters the test route.

System simulation may take place with standard programs (e.g. LMS or MATLAB) in real time and may be used for modeling/driving the drive technology.

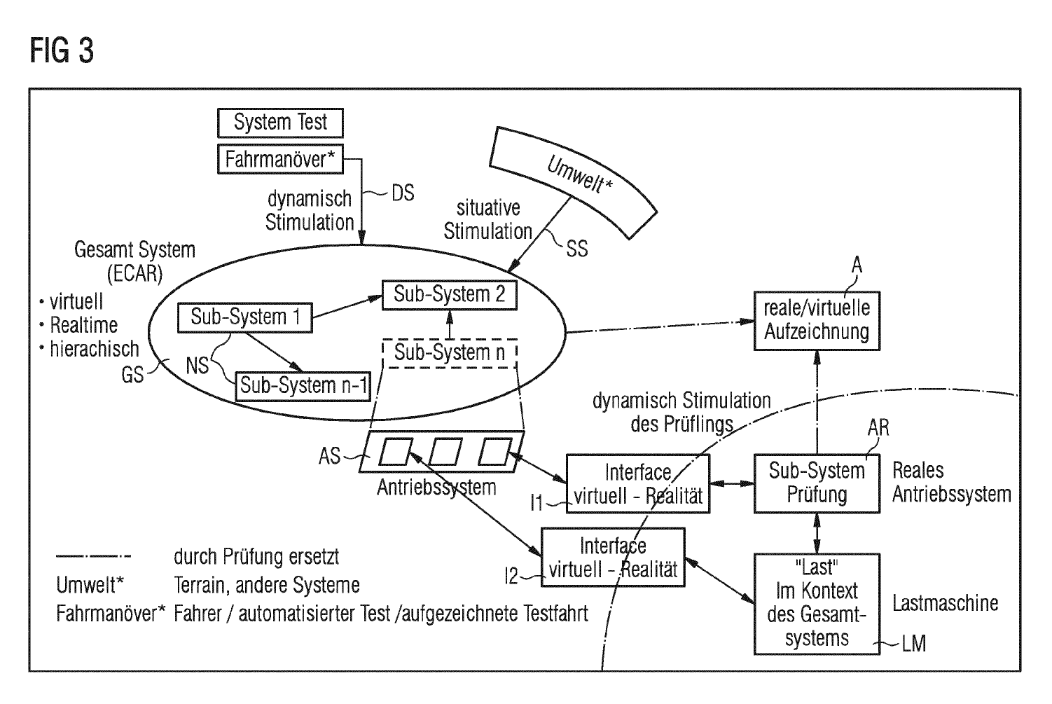

FIG. 3 shows another representation for the example of FIG. 2. A virtual overall system GS structured hierarchically and simulated in real time (e.g., the constructed of subsystems being shown are simulated by driving maneuver in a system test with the aid of a dynamic simulation DS and by situative simulation SS of the environment). In this context, the virtual subsystems may be replaced by existing components. For example, in this case the drive system AS, a subsystem test subject AR (e.g., a drive system actually present) being loaded by interfaces I1, I2, via a load machine LM which generates a corresponding loading in the sense of the overall system for the drive system. Finally, a recording A is made of the data of the overall system GS and of the data of a subsystem test subject AR (e.g., of the real drive system in this case).

The present embodiments provide for a temporarily parallel and spatially distributed integration and a corresponding test of components at different levels (e.g., the right-hand branch of the V model that may only take place on the part of the system developer). Control and regulation functions, or processes for the overall system level, may already be developed, although not all subsystems are present. No parallel installations are necessary on which new processes are run in advance.

For example, overall safety-critical systems may be tested in the laboratory before the real overall system is tested in a real environment. Some essential components of the development method may include real-time multiphysics models from the simulation and the automatic system tests of “HIL” may be reused.

The integration of the present embodiments into CAx tools may be provided. An “App store” for corresponding system models or real-time system models may also be provided.

The subject matter of this disclosure may be transferred to other domains and is applicable, apart from the system control technology, in fields of traditional product development and of the solution business.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for computer-supported development of an overall system, the overall system comprising subsystems, the method comprising:
generating, in real time, test vectors for simulating subsystems dynamically from measurements of all available subsystems;
generating, in real time, unavailable subsystems dynamically by simulation; and
simulating an environment of the overall system, wherein input and output variables of the overall system are generated dynamically and situatively, and the input and output variables are provided to all subsystems.

2. The method of claim 1, wherein, at least in individual development phases of the right-hand branch of a V model, a combination of real products and virtual performance models are simulated in real time,
wherein the development stages “MIL”, “SIL”, “VPIL” and “HIL” are present, wherein the development stages “MIL”, “SIL”, “VPIL” comprise an environmental model (U), a reusable multiphysics model (MP) and a software; and
wherein the development stage “HIL” further comprises a residual physics unit for simulation of the parts of a product only present virtually.
